(19) United States
(12) Patent Application Publication
(10) Pub. No.: US 2006/0083033 A1
(43) Pub. Date: Apr. 20, 2006

(54) Voltage generator, method of generating voltage, display device having the voltage generator and apparatus for driving the display device

(75) Inventors: Jae-Hoon Myung, Seoul (KR); Hoe-Woo You, Seoul (KR); Jin-Oh Kwag, Suwon-si (KR); Sung-Ho Lee, Hwaseong-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/251,402

(22) Filed: Oct. 14, 2005

(30) Foreign Application Priority Data
Oct. 18, 2004 (KR) 2004-83150

(51) Int. Cl. H02M 3/18

(52) U.S. Cl. 363/59

(57) ABSTRACT

A voltage generator includes a first voltage booster and a second voltage booster. The first voltage booster boosts an input voltage to generate a first boosted voltage applied to a load. The second voltage booster generates a second boosted voltage applied to the load when the first boosted voltage is out of a critical range. The second boosted voltage is generated by the voltage generator when the first boosted voltage is applied to the load. Therefore, the second boosted voltage may compensate for an instability of first boosted voltage.

### CROSS-REFERENCE TO RELATED APPLICATION

This application relies for priority under 35 U.S.C. § 119 of Korean Patent Application No. 2004-83150 filed on Oct. 18, 2004, the contents of which are herein incorporated by reference in its entirety.

### BACKGROUND OF THE INVENTION

1. Field of the Invention

The present invention relates to a voltage generator, a method of generating a voltage, a display device having the voltage generator and an apparatus for driving the display device. More particularly, the present invention relates to a voltage generator capable of stabilizing an output voltage, a method of generating a stabilized voltage, a display device having the voltage generator and an apparatus for driving the display device.

2. Description of the Related Art

In general, a power supply device of a liquid crystal display (LCD) module includes a direct-current to direct-current voltage converter (DC to DC converter), and a DC/AC backlight inverter, etc. The DC to DC converter converts an external DC voltage into driving voltages of a logic circuit, a gate ON voltage VDD and a gate OFF voltage VSS, a gamma reference voltage VREF for a data voltage and a common voltage VCOM. Generally, the driving voltage of the logic circuit is about 5V or less (e.g., about 3.3V).

Thus, the DC to DC converter boosts the external DC voltage to a DC voltage having a predetermined level and generates the driving voltages by using the DC voltage having the predetermined level.

In designing the DC to DC converter, an output voltage ripple and a voltage drop are problems to be solved. The driving voltage becomes unstable due to the output voltage ripple and deteriorates the operation characteristics and display quality.

### BRIEF SUMMARY OF THE INVENTION

A first aspect of the present invention provides a voltage generator capable of stabilizing an output voltage. Another aspect of the invention provides a method of generating a voltage (e.g., by using the above voltage generator). Another aspect of the invention provides a display device having the above voltage generator. And a further aspect of the invention provides an apparatus for driving the above display device.

One aspect of the invention provides a voltage generator including a first voltage booster and a second voltage booster. The first voltage booster boosts an input voltage to generate a first boosted voltage (that is applied to a load which may include display voltage generation sections). The voltage generation sections may comprise: a gate voltage generation section that generates a first gate voltage to operate the first gate driving section; and a gamma voltage generation section that generates a gamma reference voltage to generate the data voltages.

The second voltage booster generates a second boosted voltage (that is also applied to the load) when the first boosted voltage is out of a predetermined (e.g., critical) range.

For example, the input voltage is applied to the second voltage booster when the first boosted voltage is applied to the load, and the second voltage booster generates the second boosted voltage to the load when the input voltage is applied to the first voltage booster.

The voltage generator may include a voltage comparison section and a switching control section. The voltage comparison section compares the first boosted voltage with a reference voltage to generate a first comparison signal and a second comparison signal. The switching control section operates (activates, enables) the second voltage booster in response to the first and second comparison signals.

Alternatively the voltage generator may include a current comparison section and a switching control section. The current comparison section compares a current corresponding to the first boosted voltage with a reference current to generate a first comparison signal and a second comparison signal. The switching control section operates (activates, enables) the second voltage booster in response to the first and second comparison signals.

In another aspect of the invention, the method for generating the voltage by using the above mentioned voltage generator is as follows. An input voltage is boosted to generate a first boosted voltage that is applied to a load. When the first boosted voltage is unstable, a second boosted voltage is additionally applied to the load. The second boosted voltage is applied to the load when the first boosted voltage is applied to the load, and the second boosted voltage is applied to the load when the first boosted voltage is unstable.

For example, the first boosted voltage may be compared with a reference voltage to generate a first comparison signal and a second comparison signal. In response to the first and second comparison signals, the second voltage booster operates (is activated, enabled) and the second boosted voltage is selectively applied to the load.

Alternatively, a current corresponding to the first boosted voltage may be compared with a reference current to generate a first comparison signal and a second comparison signal. In response to the first and second comparison signals, the second voltage booster operates (is activated, enabled) and the second boosted voltage is applied to the load.

In another aspect of the invention, the display device includes a first display panel and a (data) driving section.

The first display panel includes a first substrate. The first substrate includes a first display region, a first peripheral region and a first gate driving section. The first display region includes a plurality of first data lines and a plurality of first gate lines to display an image. The first gate driving section is formed at the first peripheral region to generate a first gate signal to the first gate lines. When the first boosted voltage is unstable, the driving section generates a second boosted voltage. Thus the driving section generates the first driving voltages by using the first and second boosted voltages to generate the first driving voltages applied to the first display panel. The driving section is disposed at the first peripheral region.

The display device may further include a second display panel. The second display panel is electrically connected to the first display panel. The second display panel includes a second substrate. The second substrate includes a second display region, a second peripheral region and a second gate driving section. The second display region includes a plurality of second data lines and a plurality of second gate lines (used to display an image). The second gate driving section is formed at the second peripheral region to generate a second gate signal. The driving section generates second driving voltages applied to the second display panel.

The (data) driving section includes a first voltage booster, a second voltage booster and a voltage generation section. The first voltage booster boosts an input voltage to generate the first boosted voltage. The voltage generation sections (the load) generate the driving voltages by using the first boosted voltage. When the first boosted voltage is unstable, the second voltage booster boosts the input voltage to generate the second boosted voltage. The second boosted voltage is applied to the load when the first boosted voltage is applied to the load. And the second boosted voltage is applied to the load when the first boosted voltage is unstable.

In another aspect of the invention, the apparatus for driving the above mentioned display device includes a data driver, a gate control section and a voltage generation section. Based on a gamma reference voltage, the data driver converts an image data into data voltages and generates the data voltages applied to the data lines. The gate control section generates gate voltages and gate control signals applied to the gate driving section. The voltage generation section generates the gamma reference voltage and the gate voltages by using the first boosted voltage. When the first boosted voltage is out of a predetermined (e.g., critical) range, the voltage generation section generates the gamma reference voltage and the gate voltage by using the first and second boosted voltages.

The data driver, the gate control section and the voltage generation section may be formed as a chip disposed at the peripheral region,

According to another embodiment, there is provided a method for generating the voltage by using the voltage generator, the display device having the voltage generator and the apparatus for driving the display device, wherein when the first boosted voltage is unstable, the second boosted voltage is generated so that a stable boosted voltage may be provided. Therefore, stable driving voltages may be applied to the display device.

### BRIEF DESCRIPTION OF THE DRAWINGS

The above and other features of the present invention will become more apparent to persons skilled in the art by reference to the following detailed description when considered in conjunction with the accompanying drawings. It should be understood that the exemplary embodiments of the invention described below may be varied and modified in many different ways without departing from the inventive principles disclosed herein, and the scope of the invention is therefore not limited to these particular following embodiments. Rather, these embodiments are provided so that this disclosure will be through and complete, and will fully convey the concept of the invention to those skilled in the art by way of example and not of limitation.

Hereinafter, the invention will be described in detail with reference to the accompanying drawings, wherein:

FIG. 1 is a block diagram illustrating a voltage generator in accordance with an exemplary embodiment of the present invention;

FIG. 2 is a circuit diagram of the voltage generator shown in FIG. 1;

FIG. 3 is a block diagram illustrating a voltage generator in accordance with another exemplary embodiment of the present invention;

FIG. 4 is a circuit diagram of the voltage generator shown in FIG. 3;

FIGS. 5A to 5H are timing diagrams illustrating an operation of the voltage generator of FIG. 4;

FIG. 6 is a plan view illustrating a display device in accordance with an exemplary embodiment of the present invention;

FIG. 7 is a block diagram of the (data) driving section 350 in the device of FIG. 6;

FIG. 8A is a block diagram of a voltage generation section 330 shown in FIG. 7 in accordance with the exemplary voltage generator of FIG. 1;

FIG. 8B is a block diagram of a voltage generation section 330 shown in FIG. 7 in accordance with the exemplary voltage generator shown in FIG. 4;

FIG. 9 is a block diagram of the gate driving section 380 shown in FIG. 6;

FIG. 10 is a plan view illustrating a display device in accordance with another exemplary embodiment of the present invention;

FIG. 11 is a block diagram of the (data) driving section 420 shown in FIG. 10;

FIG. 12 is a block diagram of the first gate driving section 440 shown in FIG. 10; and

FIG. 13 is a block diagram of the second gate driving section 510 shown in FIG. 10.

### DETAILED DESCRIPTION OF THE EXEMPLARY EMBODIMENTS

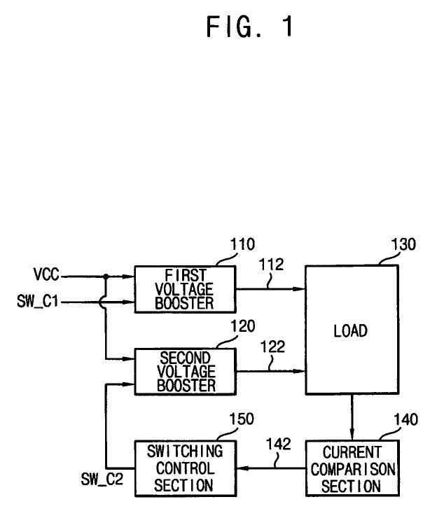

FIG. 1 is a block diagram illustrating a voltage generator in accordance with an exemplary embodiment of the present invention.

Referring to FIG. 1, the voltage generator includes a first voltage booster 110, a second voltage booster 120, a current comparison section 140 and a switching control section 150. FIG. 1 also shows a load 130 connected to the voltage generator.

The first voltage booster 110 boosts an input voltage VCC to a first boosted voltage 112 (e.g., at line 112) in response to a first switching control signal SW_C1 and applies the first boosted voltage 112 to the load 130. The first boosted voltage 112 corresponds to multiple times (m1, VCC×m1; where m1 is greater than one) the input voltage VCC. The current comparison section 140 compares a current corresponding to the first boosted voltage 112 with a reference current to apply a comparison result signal 142 to the switching control section 150. The switching control section 150 applies a second switching control signal SW_C2 to the second voltage booster 120 based on the comparison result signal 142 provided by the current comparison section 140. The second switching control signal SW_C2 controls an operation of the second voltage booster 120.

The current comparison section 140 generates a first comparison signal (at 142) that is applied to the switching control section 150 when the current applied to the load 130 is larger than the reference current. In addition, the current comparison section 140 generates a second comparison signal (at 142) that is applied to the switching control section 150 when the current applied to the load 130 is smaller than the reference current. As a result, the switching control section 150 stops the operation of (inactivates) the second voltage booster 120 when the first comparison signal is applied (at 142) to the switching control section 150, but operates (activates) the second voltage booster 120 when the second comparison signal is applied (at 142) to the switching control section 150.

When the second voltage booster 120 operates, the second voltage booster 120 boosts the input voltage VCC to a second boosted voltage 122 (e.g., at line 122) in response to the second switching control signal SW_C2 in order to apply the second boosted voltage 122 to the load 130. The second boosted voltage is multiple (m2) times of the input voltage VCC (e.g., m2×VCC; where m2 is greater than one). The switching control section 150 controls the second voltage booster 120 such that: the second voltage booster 120 generates the second boosted voltage 122 when the first voltage booster 110 applies the first boosted voltage 112 to the load 130; and the second voltage booster 120 applies the second boosted voltage 122 to the load 130 when the first voltage booster 110 generates the first boosted voltage 112.

In other words, the second boosted voltage 122 is applied to the load 130 when the first boosted voltage 112 is unstably applied to the load, whereby a stable boosted voltage is applied to the load 130.

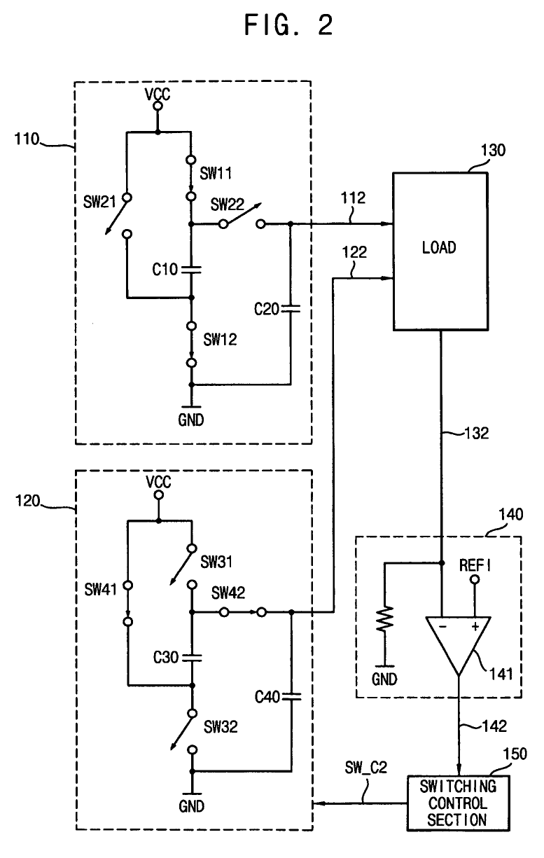

FIG. 2 is a circuit diagram of the voltage generator of FIG. 1.

Referring to FIG. 2, the first voltage booster 110 includes first switches SW11 and SW12, a first capacitor C10 that is electrically connected to (between) the first switches SW11 and SW12, second switches SW21 and SW22 and a second capacitor C20. The first capacitor C10 is switchably connected in series between the second switches SW21 and SW22, and between the input voltage VCC and the second capacitor C20. When the first switches SW11 and SW12 are turned ON and the second switches SW21 and SW22 are turned OFF, the second capacitor C20 is electrically charged with the input voltage VCC. Then, when the first switches SW11 and SW12 are turned OFF and the second switches SW21 and SW22 are turned ON, the second capacitor C20 is charged with double the input voltage VCC (2×VCC). Thus, the first voltage booster 110 applies the first boosted voltage 112 to the load 130.

The current comparison section 140 compares a reference current REFI with the current corresponding to the first boosted voltage (at 112). The current comparison section 140 outputs (at 142) a first comparison signal (e.g., a binary LOW voltage) when the current is larger than the reference current REFI, and outputs (at 142) a second comparison signal (e.g., a binary HIGH voltage) when the current is smaller than the reference current REFI.

The switching control section 150 outputs a second switching control signal SW_C2 in response to (based on) the comparison result signal 142 of the current comparison section 140. The second switching control signal SW_C2 controls the second voltage booster 120. Thus, the second switching control signal SW_C2 stops the operation of the second voltage booster 120 when the first comparison signal (e.g., LOW) is applied to the switching control section 150; Conversely, the second switching control signal SW_C2 operates (enables) the second voltage booster 120 when the second comparison signal (e.g., HIGH) is applied to the switching control section 150. When the first boosted voltage 112 is outputted from the first voltage booster 110, the switching control section 150 controls the second voltage booster 120. When the input voltage VCC is applied to the first voltage booster 110, the switching control section 150 controls the second voltage booster 120 to generate the second boosted voltage 122.

The second voltage booster 120 includes third switches SW31 and SW32, a third capacitor C30 that is electrically connected to (between) the third switches SW31 and SW32, fourth switches SW41 and SW42 and a fourth capacitor C40. The third capacitor C30 is electrically switchably connected in series between the fourth switches SW41 and SW42, and between the input voltage VCC and the fourth capacitor C40. When the third switches SW31 and SW32 are turned ON and the fourth switches SW41 and SW42 are turned OFF, the third capacitor C30 is electrically charged with the input voltage VCC. Then, when the third switches SW31 and SW32 are turned OFF and the fourth switches SW41 and SW42 are turned ON, the fourth capacitor C40 is electrically charged with double the input voltage VCC (2×VCC). Therefore, the second voltage booster 120 generates the second boosted voltage 122 to the load 130.

Thus, when the first boosted voltage 112 applied to the load 130 is unstable, the voltage generator operates (activates) the second voltage booster 120 to apply the second boosted voltage (at) 122 to the load 130, so that the boosted voltage that is applied to the load 130 is stabilized.

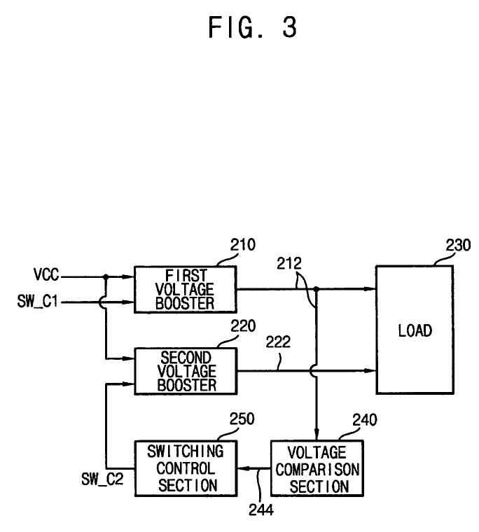

FIG. 3 is a block diagram illustrating a voltage generator in accordance with another exemplary embodiment of the present invention.

Referring to FIG. 3, the voltage generator includes a first voltage booster 210, a second voltage booster 220, a voltage comparison section 240 and a switching control section 250. FIG. 3a also shows a load 230 electrically connected to the voltage generator.

The first voltage booster 210 boosts an input voltage VCC to a first boosted voltage 212 in response to a first switching control signal SW_C1 in order to apply the first boosted voltage 212 to the load 230. The first boosted voltage 212 is a multiple (m1) of the input voltage VCC (e.g., m1×VCC; where m1 is greater than one). The voltage comparison section 240 compares the first boosted voltage 212 with a reference voltage to apply a comparison result signal 244 (at 244) to the switching control section 250.

The switching control section 250 applies a second switching control signal SW_C2 to the second voltage booster 220 in accordance with the comparison result signal 244 of the voltage comparison section 240. The second switching control signal SW_C2 controls an operation of the second voltage booster 220.

Thus, the voltage comparison section 240 generates a first comparison signal when the voltage applied to the load 230 is higher than the reference voltage. Conversely, the voltage comparison section 240 outputs a second comparison signal when the voltage applied to the load 230 is lower than the reference voltage. Therefore, the switching control section 250 stops the operation of (inactivates, disables) the second voltage booster 220 when the first comparison signal is applied to the switching control section 150, and operates (activates, enables) the second voltage booster 220 when the second comparison signal is applied to the switching control section 150.

When the second voltage booster 220 is operated (activated, enabled), the second voltage booster 220 boosts the input voltage VCC to a second boosted voltage 222 in response to the second switching control signal SW_C2 in order to apply the second boosted voltage 222 to the load 230. The second boosted voltage 222 is multiple m2 of the input voltage VCC (e.g., m2×VCC; where m2 is greater than one). When the first voltage booster 210 generates the first boosted voltage 212, the switching control section 250 controls the second boosted voltage 222 to be output by the second voltage booster 220. When the first boosted voltage 212 is applied to the load 230, the switching control section 250 controls the second voltage booster 220 to output the second boosted voltage 222 to the load 230.

Therefore, the second boosted voltage 222 is applied to the load 230 when the first boosted voltage 212 is unstably applied to the load 230, so that a stable boosted voltage is applied to the load 230.

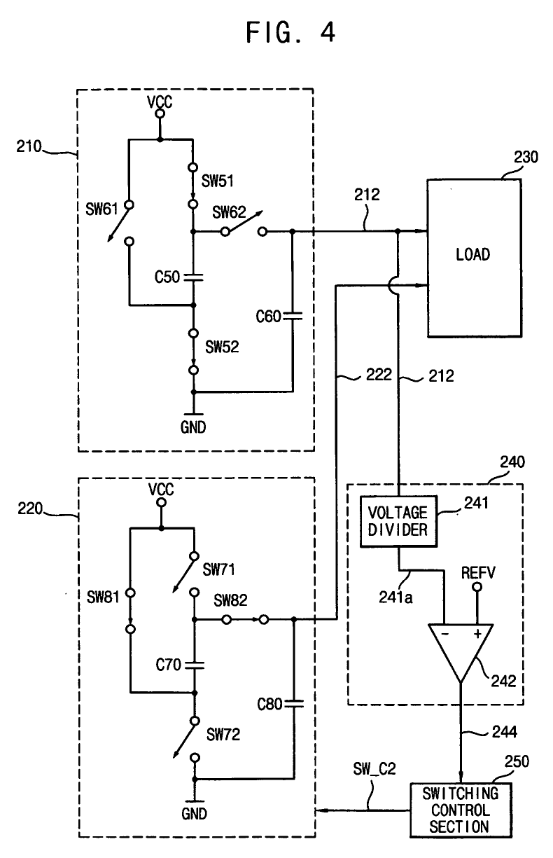

FIG. 4 is a circuit diagram of the voltage generator shown in FIG. 3.

Referring to FIG. 4, the first voltage booster 210 includes fifth switches SW51 and SW52, a fifth capacitor C50 that is connected to (between) the fifth switches SW51 and SW52, sixth switches SW61 and SW62 and a sixth capacitor C60 connected between switch SW62 and the ground voltage. The fifth capacitor C50 is switchably electrically connected between the sixth switches SW61 and SW62, and between the input voltage VCC and sixth capacitor C60. When the fifth switches SW51 and SW52 are turned ON and the sixth switches SW61 and SW62 are turned OFF, the fifth capacitor C50 is electrically charged with the input voltage VCC. Then, when the fifth switches SW51 and SW52 are turned OFF and the sixth switches SW61 and SW62 are turned ON, the sixth capacitor C60 is electrically charged with the first boosted voltage 212 and the first boosted voltage 212 is double the input voltage VCC (e.g., m1=2).

The voltage comparison section 240 includes a voltage divider 241 and a comparator 242. The voltage divider 241 divides the first boosted voltage 212 into a divided voltage 241a. The comparator 242 compares a reference voltage REFV with the divided voltage 241a to generate a comparison result signal 244. When the divided voltage 241a is higher than the reference voltage REFV, the comparator 242 generates a first comparison signal (e.g., binary LOW). When the divided voltage 241a is lower than the reference voltage REFV, the comparator 242 generates a second comparison signal (e.g., binary HIGH).

The switching control section 250 generates a second switching control signal SW_C2 in response to the comparison result signal 244 output by the voltage comparison section 240. The second switching control signal SW_C2 controls an operation of the second voltage booster 220. The second switching control signal SW_C2 stops the operation of (inactivates, deactivates, disables) the second voltage booster 220 when the first comparison signal (e.g., LOW) is applied to the switching control section 250. When the first boosted voltage 212 is outputted from the first voltage booster 210, the switching control section 250 controls the second voltage booster 220. The switching control section 250 controls the second voltage booster 220 to generate the second boosted voltage 222.

The second voltage booster 220 includes seventh switches SW71 and SW72 connected in series between the input voltage VCC and the ground voltage, a seventh capacitor C70 that is electrically connected to (between) the seventh switches SW71 and SW72, eighth switches SW81 and SW82 and an eighth capacitor C80. The seventh capacitor C70 is switchably electrically connected between the eighth switches SW81 and SW82, and between the input voltage VCC and the eighth capacitor C80. When the seventh switches SW71 and SW72 are turned ON and the eighth switches SW81 and SW82 are turned OFF, the seventh capacitor C70 is electrically charged with the input voltage VCC. Then, when the seventh switches SW71 and SW72 are turned OFF and the eighth switches SW81 and SW82 are turned ON, the eighth capacitor C80 is electrically charged with the second boosted voltage 222. The second boosted voltage 222 is double of the input voltage VCC (e.g., m2=2).

Therefore, when the first boosted voltage 212 that is applied to the load 230 is unstable, the voltage generator operates the second voltage booster 220 to apply the second boosted voltage 222 to the load 230, so that the boosted voltage applied to the load 230 is stabilized.

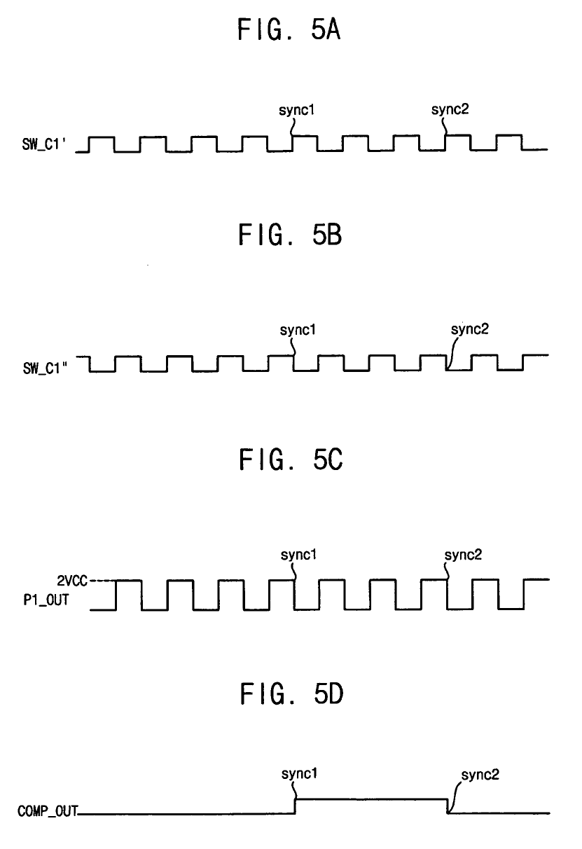

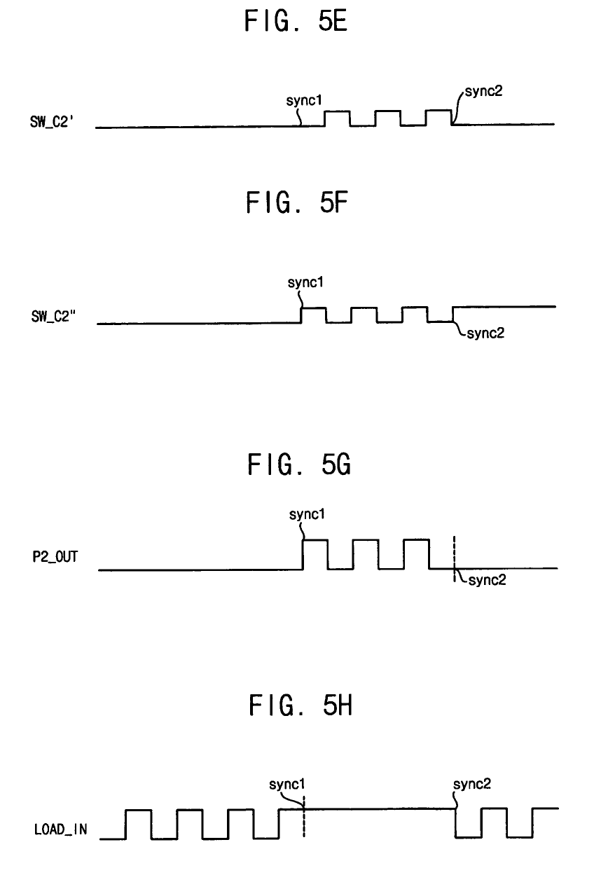

FIGS. 5A to 5H are timing diagrams illustrating an input signal and an output signal of the voltage generator of FIG. 4. The timing diagrams in FIGS. 5A to 5H are synchronized at first and second time points sync1 and sync2.

Referring to FIGS. 4, 5A and 5B, an input voltage VCC and a first switching control signal SW_C1 are applied to the first voltage booster 210. The first switching control signal SW_C1 includes a first switch control signal SW_C1′ and a second (complementary) switch control signal SW_C1″. The first switch control signal SW_C1′ controls the fifth switches SW51 and SW52. The second switch control signal SW_C1″ controls the sixth switches SW61 and SW62. The first switch control signal SW_C1′ has a phase that is opposite to the phase of the second switch control signal SW_C1″. Thus, when the first switch control signal SW_C1′ is at a High level, the second switch control signal SW_C1″ is at a Low level.

Referring to FIGS. 4 and 5C, the first voltage booster 210 generates a first boosted voltage P1_OUT. That is, when the first control signal SW_C1′ is in a High level and the second control signal SW_C1″ is in a Low level, the seventh capacitor C70 is electrically charged with the input voltage VCC. Thereafter, when the first control signal SW_C1′ is in a low level and the second control signal SW_C1″ is in a high level, the eighth capacitor C70 is electrically charged with double the input voltage VCC. The first boosted voltage P1_OUT is applied to the load 230.

Referring to FIGS. 4 and 5D, the voltage comparison section 240 compares the first boosted voltage with the reference voltage REFV to generate a comparison result signal COMP_OUT. The voltage comparison section 240 generates a first comparison signal (e.g., LOW before synch1) when the first boosted voltage is higher than the reference voltage REFV. The voltage comparison section 240 generates a second comparison signal (e.g., HIGH between sync1 and sync2), when the first boosted voltage is lower than the reference voltage REFV.

In response to the first and second comparison signals (LOW and HIGH), the switching control section 250 generates a second switching control signal SW_C2 that controls the seventh switches SW72 and SW72 and the eighth switches SW81 and SW82 of the second voltage booster 220.

Referring to FIGS. 5E and 5F, the second switching control signal SW_C2 includes a third switch control signal SW_C2′ and a (complementary) fourth switch control signal SW_C2″. The third switch control signal SW_C2′ controls the seventh switches SW71 and SW72. The fourth switch control signal SW_C2″ controls the eighth switches SW81 and SW82. The third switch control signal SW_C2′ has a phase that is opposite to the phase of the fourth switch control signal SW_C2″.

Referring to FIG. 5G, the second voltage booster 220 generates a second boosted voltage P2_OUT in response to the second switching control signal SW_C2. When the third control signal SW_C2′ is in a High level and the fourth control signal SW_C2″ is in a Low level, the seventh capacitor C70 is electrically charged with the input voltage VCC. Thereafter, when the third control signal SW_C2′ is in a Low level and the fourth control signal SW_C2″ is in a High level, the eighth capacitor C80 is electrically charged with double the input voltage VCC (2×VCC or 2 VCC). The second boosted voltage P2_OUT is applied to the load 230.

The second switching control signal SW_C2 has a phase that is opposite to the phase of the first switching control signal SW_C1. Therefore, when the seventh capacitor C70 of the first voltage booster 210 is electrically charged with the input voltage VCC, the eighth capacitor C80 of the second voltage booster 220 applies the second boosted voltage (2 VCC) to the load 230. And, when the sixth capacitor C60 of the first voltage booster 210 applies the first boosted voltage of 2 VCC to the load 230, the seventh capacitor C70 of the second voltage booster 220 is electrically charged with the input voltage of VCC.

Referring to FIG. 5H, the combination of first boosted voltage and the second boosted voltage (which may be at different times the first boosted voltage alone or the first and second boosted voltages) (LOAD_IN) is applied to the load 230 based on the stability of the first boosted voltage. When the first boosted voltage outputted from the first voltage booster 210 is unstable, the second voltage booster 220 is operated (activated, enabled) by the switching control section 250. The switching control section 250 controls the output timing of the first voltage booster 210 and of the second voltage booster 220 so that an output voltage ripple which would otherwise be caused by a delay of applying the boosted voltage to the load may be prevented. In addition, the second boosted voltage compensates for the instability of the first boosted voltage so that a voltage drop may be eliminated.

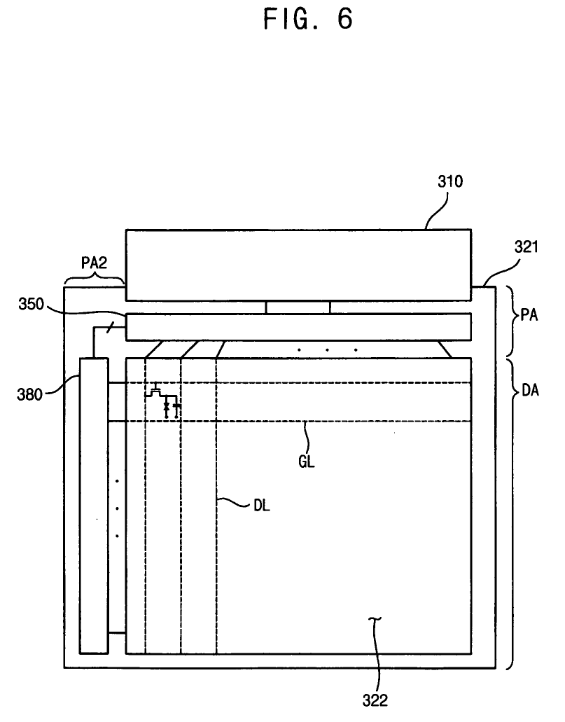

FIG. 6 is a plan view illustrating a display device in accordance with an exemplary embodiment of the present invention.

Referring to FIG. 6, the display device includes a flexible circuit substrate 310, an array substrate 321, a color filter substrate 322, a (data) driving section 350 and a gate driving section 380.

The flexible circuit substrate 310 receives a data signal and a control signal from an external device, and transmits the data and control signals to the (data) driving section 350.

The array substrate 321 includes a display region DA corresponding to the color filter substrate 322 and a peripheral region PA. The display region DA contains a plurality of data lines DL and a plurality of transverse gate lines GL. The data lines DL are in columns arrayed in a row direction of the display region DA. The gate lines GL are in rows arrayed in a column direction of the display region DA. In other words, each of the gate lines GL is substantially perpendicular (transverse) to each of the data lines DL. The intersection of data and gate lines DL and GL define a plurality of pixels (not shown). Each of the pixels includes a switching device (e.g., a transistor having a gate) that is electrically connected to one of the data lines DL and one of the gate lines GL. The display region DA is a liquid crystal display (LCD) panel that has the array substrate 321, the color filter substrate 322 and a liquid crystal layer (not shown).

The (data) driving section 350 may be formed as a single chip that is mounted on the peripheral region PA. The (data) driving section 350 operates the display region DA in response to the data signal and the control signal that are transmitted from the flexible circuit substrate 310. The (data) driving section 350 generates gate control signals to the gate driving section 380, and generates driving voltages to the display region DA.

The gate driving section 380 is an integrated circuit that is contained in another peripheral region PA2, and generates a gate signal to the gate lines GL in response to the gate control signals.

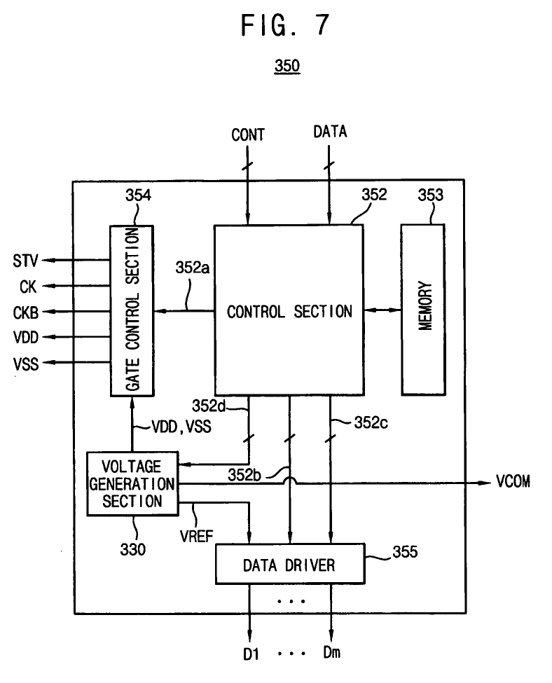

FIG. 7 is a bock diagram of the (data) driving section 350 shown in FIG. 6.

Referring to FIG. 7, the (data) driving section 350 includes a control section 352, a memory 353, a DC voltage generation section 330, a gate control section 354 and a data driver 355.

The control section 352 receives a data signal DATA and a control signal CONT from an external device. The control signal CONT may include a horizontal synchronization signal, a main clock signal, a data enable signal and other control signals known in the art.

The control section 352 stores the data signal DATA in the memory 353 in response to the control signal CONT. The control section 352 outputs gate control signals 352a to the gate control section 354. The gate control signals 352a include a vertical start signal STV, a first clock signal CK and a second clock signal CKB. The control section 352 applies source control signals 352b to the data driver 355 and reads data that is stored in the memory 353 and outputs a data signal 352c. The source control signals 352b may include a horizontal start signal STH, a load signal, an inversion signal, etc. The control section 352 applies a control signal 352d such as a main clock signal, an inverted clock signal, etc. to the voltage generation section 330.

The memory 353 stores the data signal DATA in frame units or in line units. In accordance with a control of the control section 352, the data signal 352c is written in the memory 353 or read out from the memory 353.

The voltage generation section 330 generates the driving voltages from power (voltage VCC) that is provided from outside of the driving section 350. The voltage generation section 330 includes a first voltage booster and a second voltage booster, as in the embodiments of FIGS. 1-4. When a first boosted voltage that is generated from the first voltage booster is unstable, the second voltage booster is operated (activated, enabled) to generate a stable boosted voltage. Therefore, the driving voltages output from voltage generation section 330 based on the stabilized boosted voltage become stable. The driving voltages output from voltage generation section 330 may include gate voltages VSS and VDD, a gamma reference voltage VREF, a common voltage VCOM, etc. The gate voltages VSS and VDD are supplied to the gate control section 354. The gamma reference voltage VREF is supplied to the data driver 355. The common voltage VCOM is applied to a common electrode (not shown) that is within the display region DA.

The gate control section 354 applies the gate control signals 352a and the gate voltages VSS and VDD to the gate driving section 380 that is contained (e.g., integrated) at a peripheral region of the array substrate.

The data driver 355 converts data signals that are read out from the memory 353 into analog data voltages D1 . . . Dm based on the gamma reference voltage VREF, to apply the analog data voltages D1 . . . Dm to data lines DL.

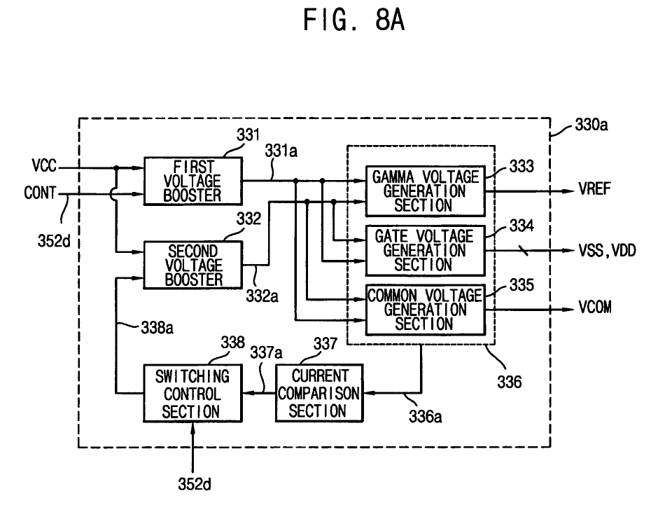

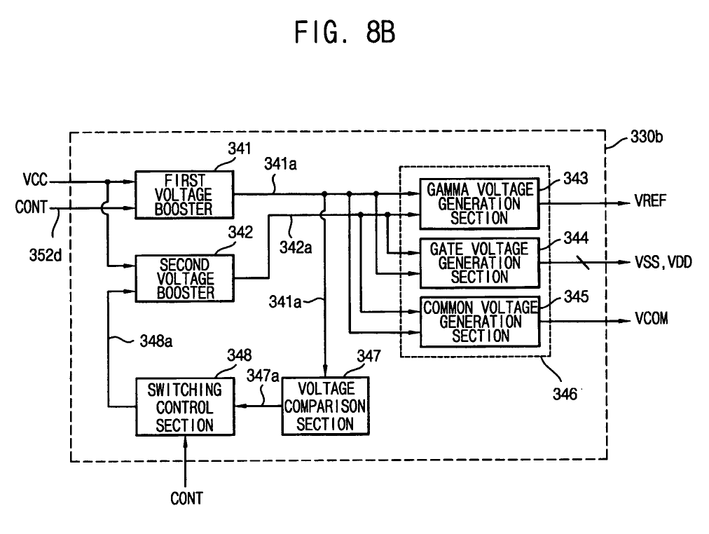

FIG. 8A is a block diagram illustrating the voltage generation section 330 shown in FIG. 7 in accordance with the exemplary embodiment of the voltage generator of FIGS. 1 & 2.

Referring to FIG. 8A, the voltage generation section 330a includes a first voltage booster 331, a second voltage booster 332, a load 336, a current comparison section 337 and a switching control section 338.

The first voltage booster 331 boosts an input voltage VCC to apply a first boosted voltage 331a to the load 336. The first boosted voltage 331a is a predetermined multiple (m1; e.g., m1=2) of the input voltage VCC.

In accordance with a control signal (at 338a) of the switching control section 338, the second voltage booster 332 boosts the input voltage VCC to apply a second boosted voltage (at 322a) to the load 336.

The load 336 includes a gamma voltage generation section 333, a gate voltage generation section 334 and a common voltage generation section 335. The gamma voltage generation section 333 generates a gamma reference voltage VREF by using the first boosted voltage 331a or the combined first and second boosted voltages 331a and 332a. The gate voltage generation section 334 generates gate voltages VSS and VDD that are applied to the gate control section 354 (see FIG. 7) by using the first boosted voltage 331a or the combined first and second boosted voltages 331a and 332a. The common voltage generation section 335 generates a common voltage VCOM that is applied to the common electrode by using the first boosted voltage 331a or the combined first and second boosted voltages 331a and 332a.

The current comparison section 337 compares a current corresponding to the first boosted voltage 331a with a reference current to generate a comparison result signal 337a. The switching control section 338 controls an operation of (the activation of) the second voltage booster 332 in response to the comparison result signal 336a. The comparison result signal 336a includes a first comparison signal and a second comparison signal. The first comparison signal is generated when the current corresponding to the first boosted voltage 331a is larger than the reference current. The second comparison signal is generated when the current corresponding to the first boosted voltage 331a is smaller than the reference current.

The switching control section 338 controls an operation (activation) of the second voltage booster 332 in response to the first and second comparison signals. For example, when the current corresponding to the first boosted voltage 331a is smaller than the reference current, the current comparison section 337 generates a second comparison signal to the switching control section 338. In response to the second comparison signal, the switching control section 338 generates a switching control signal 338a that operates (activates) the second voltage booster 332.

The switching control signal 338a controls the second voltage booster 332 to generate the second boosted voltage 332a when the first boosted voltage 331 generated by the first voltage booster 331. And, the switching control signal 338a controls the second voltage booster 332 to generate the second boosted voltage 332a when the first boosted voltage 331a is unstably generated by the first voltage booster 331.

Therefore, the voltage generation section 330a generates the stable driving voltages from the stabilized boosted voltages.

FIG. 8B is a block diagram illustrating a voltage generation section 330 shown in FIG. 7 in accordance with the exemplary embodiment of the voltage generator of FIG. 4.

Referring to FIG. 8B, the voltage generation section 330b includes a first voltage booster 341, a second voltage booster 342, a load 346, a voltage comparison section 347 and a switching control section 348.

The first voltage booster 341 boosts the input voltage VCC to generate a first boosted voltage 341a that is applied to the load 346. The first boosted voltage 341a is a predetermined multiple (m1; e.g., m1=2) of the input voltage VCC.

In accordance with a control signal (at 348a) of the switching control section 348, the second voltage booster 342 boosts the input voltage VCC to generate a second boosted voltage (at 342a) that is applied to the load 346.

The load 346 includes a gamma voltage generation section 343, a gate voltage generation section 344 and a common voltage generation section 345. The gamma voltage generation section 343 generates a gamma reference voltage VREF that is applied to the data driver 355 from the first boosted voltage 341a or the combined first and second boosted voltages 341a and 342a. The gate voltage generation section 344 generates gate voltages VSS and VDD that are applied to the gate control section 354 by using the first boosted voltage 341a or the combined first and second boosted voltages 341a and 342a. The common voltage generation section 345 generates a common voltage VCOM that is applied to the common electrode by using the first boosted voltage 341a or the combined first and second boosted voltages 341a and 342a.

The voltage comparison section 347 compares the first boosted voltage 341a that is applied to the load 346 with a reference voltage to generate a comparison signal (at 347a) that is applied to the switching control section 348. The comparison signal (at 347a) includes a first comparison signal and a second comparison signal. The first comparison signal is generated when the first boosted voltage 341a is higher than the reference voltage. The second comparison signal is generated when the first boosted voltage 341a is lower than the reference current.

The switching control section 348 controls an operation (activation) of the second voltage booster 342 based on the first and second comparison signals. For example, the voltage comparison section 347 generates the second comparison signal to the switching control section 348 when the first boosted voltage 341a is lower than the reference voltage.

The switching control section 348 generates a switching control signal (at 348a) in response to the second comparison signal. The switching control signal 348a operates the second voltage booster 342. The switching control signal 348a controls the second voltage booster 342 to generate the second boosted voltage (at 342a) when the first boosted voltage 341a is generated by to the first voltage booster 341. And, the switching control signal 348a controls the second voltage booster 342 to generate the second boosted voltage 342a when the first voltage booster 341 generates an unstable first boosted voltage 341a.

Therefore, the voltage generation section 330b generates the stable driving voltages by using the stable boosted voltages.

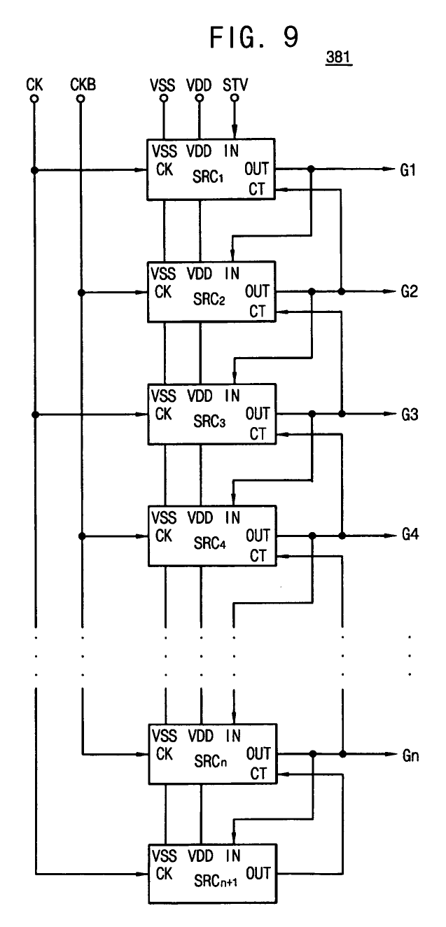

FIG. 9 is a block diagram illustrating the gate driving section 380 shown in FIG. 6.

Referring to FIG. 9, the gate driving section 380 includes a first shift register 381. The first shift register 381 includes a plurality of driving stages SRC1˜SRCn+1 that are cascade connected to one another. Thus, an output terminal OUT of each of the driving stages SRC1˜SRCn+1 is electrically connected to an input terminal IN of a following (next) driving stage so that the driving stages SRC1=18 SRCn+1 are cascade connected to one another.

The shift register 381 includes n driving stages SRC1˜SRCn corresponding to gate lines GL1˜GLn and a dummy (n+1)th driving stage SRCn+1. Each of the driving stages SRC1˜SRCn+1 includes an input terminal IN, an output terminal OUT, a control terminal CT, a clock signal input terminal CK, a first power (Off) voltage terminal VSS and a second power (On) voltage terminal VDD.

A vertical start signal STV is applied to the input terminal IN of the first driving stage SRC1. The output signal OUT that is generated from each of corresponding previous stages is applied as the vertical start signal STV to the input terminal IN of each next one of the remaining driving stages SRC2˜SRCn+1. Additionally, the driving stage may further include a carry signal generation section that generates a carry signal so that the carry signal is applied to the input terminal IN of the each of the remaining driving states SRC2˜SRCn+1.

An output terminal OUT of the each of the driving stages SRC1˜SRCn+1 is electrically connected to the gate lines GL1˜GLn (GL in FIG. 6), so that gate signals G1˜Gn that are generated from the output terminals OUT are applied to the corresponding gate lines GL1˜GLn. A first clock signal CK is applied to odd numbered driving stages. A second (complementary, inverted) clock signal CKB is applied to even numbered driving stages. The first clock signal CK has a phase that is opposite to a phase of the second clock signal CKB.

To the control terminal CT of the driving stage, the output signal of the following driving stage is applied as a control signal. Thus, the control signal that is applied to the control terminal CT will reset the output signal of the previous stage to a low level.

Therefore, gate signals G1˜Gn that are generated from the output terminals of the driving stages SRC1˜SRCn+1 are applied to the corresponding gate lines GL1˜GLn in sequence.

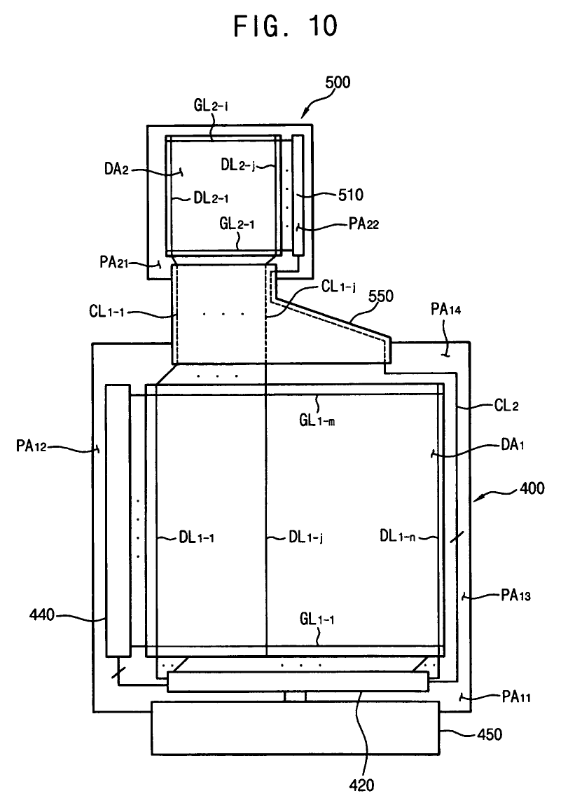

FIG. 10 is a plan view illustrating the display device in accordance with another exemplary embodiment of the present invention. Hereinafter, “i”, “n”, “j” and “m” represent a natural number that is more than one, and “i” is not more than “n”; and “j” is not more than “m”.

Referring to FIG. 10, the display device includes a first display panel 400, a first flexible circuit substrate 450, a second display panel 500 and a second flexible circuit substrate 550. The first display panel 400 displays a main image. The first flexible circuit substrate 450 electrically connects the first display panel 400 to an external equipment. The second display panel 500 displays a sub image. The second flexible circuit substrate 550 electrically connects the first display panel 400 with the second display panel 500.

The first display panel 400 includes a first array substrate, a first color filter substrate, a (data) driving section 420 and a gate driving section 440. The first array substrate includes a first display region DA1 corresponding to the first color filter substrate and a first peripheral region PA11, a second peripheral region PA12, a third peripheral region PA13, and a fourth peripheral region PA14. The first, second, third and fourth peripheral regions PA11˜PA14 surround the first display region DA1. The first display region DA1 includes a plurality n of gate lines GL1_1˜GL1_n and a plurality m of data lines DL1-1˜DL1-m that are substantially perpendicular (transverse) to the gate lines GL1_1˜GL1_n.

The (data) driving section 420 is a single chip that is mounted on the first peripheral region PA11. Data signals and control signals are applied to the driving section 420 from an external equipment through the first flexible circuit substrate 450. The driving section 420 generates (data) driving voltages and gate control signals to the first and second display panels 400 and 500.

The first gate driving section 440 is an integrated circuit that is contained in (e.g., integrated at) the second peripheral region PA12, and generates gate signals to the gate lines GL1_1˜GL1_n in response to the first gate control signals that are generated from the driving section 420.

The second display panel 500 includes a second array substrate, a second color filter substrate and a second gate driving section 510. The second array substrate includes a second display region DA2 corresponding to the second color filter substrate, and a first peripheral region PA21 and a second peripheral region PA22 that surround the second display region DA2. The second display region DA2 includes a plurality i of gate lines GL2_1˜GL2_i and a plurality j of data lines DL2_1˜DL2_j that are substantially perpendicular (transverse) to the gate lines GL2_1˜GL2_i.

The second gate driving section 510 may be formed as an integrated circuit that is mounted on the second peripheral region PA22, and generate gate signals that are outputted to the plurality i of gate lines GL2_1˜GL2_i in response to the second gate control signals that are provided from the driving section 420.

The second flexible circuit substrate 550 electrically connects the first display panel 400 to the second display panel 500. A first end portion of the second flexible circuit substrate 550 is electrically attached to the fourth peripheral region PA14 of the first display panel 400. A second (e.g., smaller) end portion of the second flexible circuit substrate 550, which is opposite the first end portion, is electrically attached to the first peripheral region PA21 of the second display panel 500.

The second flexible circuit substrate 550 includes a plurality j of connection lines CL1_1˜CL1_j. The connection lines CL1_1˜CL1_j electrically connect the plurality j of data lines DL1_1˜DL1_j of the first display panel 400 with the same number j of data lines DL2_1˜DL2_j of the second display panel 500.

In addition, the second flexible circuit substrate 550 includes a connection pattern that transmits the second gate control signals to the second gate driving section 510. The connection pattern is electrically connected to a connection line CL2 at the fourth peripheral region PA14 in order to transmit the second gate control signals of the driving section 420 to the second gate driving section 510.

Therefore, the driving voltages and the second gate control signals are applied to the second display panel 500.

For example, the size of the first display panel 400 is larger than the second display panel 500, so that the size (area) of the first display region DA1 is larger than (the area of) the second display region DA2. The resolution of the first display region DA1 may be higher than that of the second display region DA2. For example, the resolution of the first display panel 400 may be 176×220 pixels, while the resolution of the second display panel 500 is 96×64 pixels.

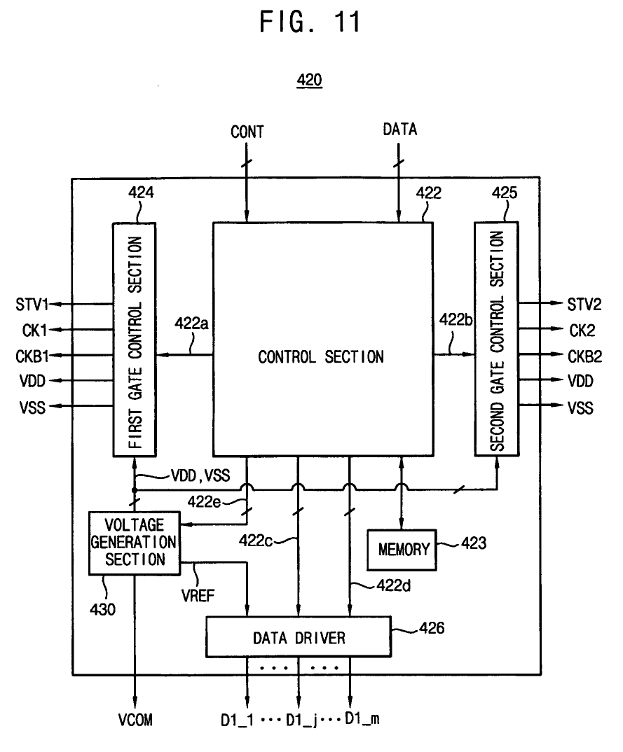

FIG. 11 is a block diagram illustrating the (data) driving section 420 shown in FIG. 10.

Referring to FIGS. 10 and 11, the (data) driving section 420 includes a control section 422, a memory device 423, a voltage generation section 430, a first gate control section 424, a second gate control section 425 and a data driver 426.

The control section 422 receives a data signal DATA and a control signal CONT from an external device. The control signal CONT includes a horizontal synchronization signal, a main clock signal, a data enable signal, etc.

The control section 422 stores the data signal DATA in the memory device 423 in response to the control signal CONT. The control section 422 generates first gate control signals 422a and second gate control signals 422b that are applied to the first and second gate control sections 424 and 425. The first gate control signals 422a include a first vertical start signal STV1, a first clock signal CK1 and a second clock signal CKB1. The second gate control signals 422b include a second vertical start signal STV2, a second clock signal CK2 and a second clock signal CKB2. The control section 422 generates source control signals 422c that are applied to the data driver 426 and reads out a data signal 422d stored in the memory device 423. The source control signals 422c include a horizontal start signal, a load signal, an inversion signal, etc. The control section 422 outputs a control signal 422e such as a main clock signal, an inverted clock signal, etc. to the voltage generation section 430.

The voltage generation section 430 generates the driving voltages by using an electric power voltage (VCC) supplied thereto. The voltage generation section 430 includes a first voltage booster and a second voltage booster. When a boosted voltage that is generated from the first voltage booster is unstable, the second voltage booster is operated to generate a stable boosted voltage. Therefore, the stable driving voltages are generated from the voltage generation section 430. In the present embodiment, the voltage generation section 430 shown in FIG. 10 may be the same as shown in FIG. 8A or in FIG. 8B. Thus, the same reference numerals will be used to refer to the same or like sections as those described in FIGS. 8A and 8B and any further explanation will be omitted.

The driving voltages include gate voltages VSS and VDD, a gamma reference voltage VREF, a common voltage VCOM, etc. The gate voltages VSS and VDD are applied to the first and second gate control sections 424 and 425. The gamma reference voltage VREF is applied to the data driver 426. The common voltage VCOM is applied to a common electrode (not shown) of the first and second display panels 400 and 500.

The first gate control section 424 generates the first gate control signals 422a and the gate voltages VSS and VDD that are applied to a first driving section 440 of the first display panel 400.

The second gate control section 425 generates the second gate control signals 422b and the gate voltages VSS and VDD that are applied to a second driving section 510 of the second display panel 500.

The data driver 426 converts the data signals that are read out from the memory device 423 into analog data voltages to generate the analog data voltages, based on the gamma reference voltage VREF, that are applied to data lines DL1_1, . . . DL1_j, . . . DL1_m. Thus, first data voltages corresponding to the first display panel 400 are applied to the m data lines DL1_1,.,DL1_m. Second data voltages corresponding to the second display panel 500 are applied to the j data lines DL1_1,.,DL1_j.

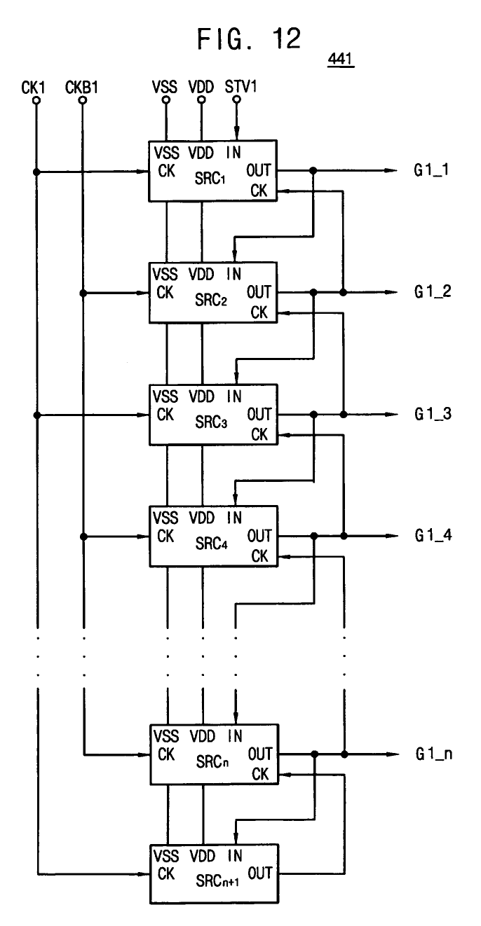

FIG. 12 is a block diagram illustrating the first gate driving section 440 shown in FIG. 10.

Referring to FIG. 12, the first gate driving section 440 includes a first shift register 441. The first shift register 441 includes a plurality (n+1) of driving stages SRC1˜SRCn+1 that are cascade connected to one another. An output terminal OUT of n of the driving stages SRC1˜SRCn+1 is connected to an input terminal IN of a following driving stage so that the driving stages SRC1˜-SRCn+1 are cascade connected to one another.

The first shift register 441 includes n driving stages SRC1˜SRCn corresponding to gate lines GL1_1˜GL1_n and one dummy driving stage SRCn+1. Each of the driving stages includes an input terminal IN, an output terminal OUT, a control terminal CT, a clock signal input terminal CK, a first power voltage terminal VCC and a second power voltage terminal VDD.

A vertical start signal STV is applied to the input terminal IN of the first driving stage SRC1. The output signal OUT that is generated from a previous stage is applied as the vertical start signal STV to the input terminal IN of each of the remaining driving stages. Additionally, the driving stage may further include a carry signal generation section that generates a carry signal so that the carry signal may be applied to the input terminal IN of the each of the remaining driving stages.

An output terminal OUT of the each of the driving stages is connected to one of the n gate lines GL1˜GLn. A first clock signal CK1 is applied to odd numbered driving stages. A (complementary, inverted) second clock signal CKB1 is applied to even numbered driving stages. The first clock signal CK1 has a phase that is opposite to the phase of the second clock signal CKB1.

Output signals of an m-th driving stage are applied to the control terminal CT of the previous (m-1)-th driving stage. Thus, the control signal of the control terminal CT will reset the output signal of the previous stage to a low level.

Therefore, n gate signals G_1, . . . . ,G1_n that are generated from the output terminals OUT of n of the driving stages are applied to the corresponding gate lines GL (GL1_1˜GL1_n) in sequence.

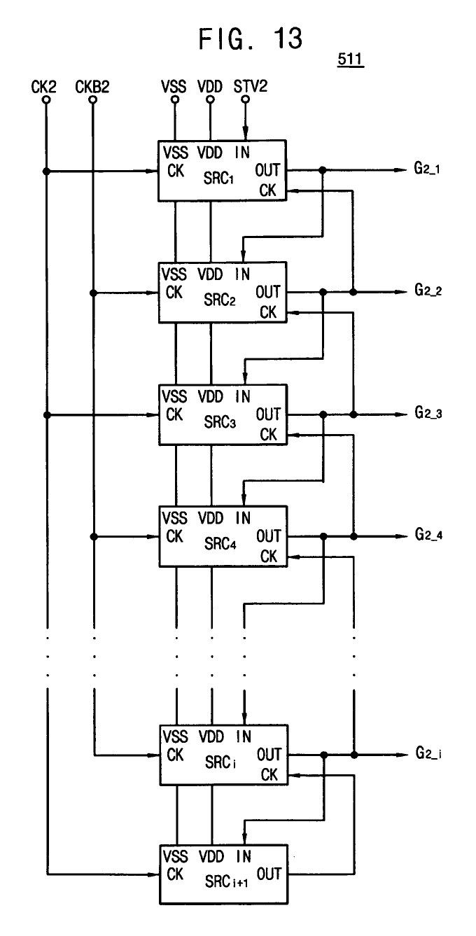

FIG. 13 is a block diagram illustrating the second gate driving section 510 shown in FIG. 10.

Referring to FIGS. 10 and 13, the gate driving section 510 includes a first shift register 511. The shift register 511 includes a plurality (i+1) of driving stages SRC1˜SRCi+1 that are cascade connected to one another. The first register includes a plurality i of driving stages SRC1˜SRCi corresponding to the plurality i of gate lines GL2_1˜GL2_i plus one dummy driving stage SRCi+1. In the present embodiment, the second gate driving section 510 shown in FIG. 13 is essentially the same as shown in FIG. 12. Thus, the same reference numerals will be used to refer to the same or like elements as those described in FIG. 12 and any further explanation will be omitted. The plurality i of gate signals G2_1, . . . ,G2_i that are generated from the i output terminals OUT of the driving stages SRC1˜SRCi are applied to the gate lines GL2_1˜GL2_i in sequence.

According to the exemplary embodiments of the invention, when the first boosted voltage that is generated from the first voltage booster is unstable, the second voltage booster is operated (activated, enabled) to generate the second boosted voltage that is also applied to the load. The second boosted voltage is generated by the voltage generator when the first boosted voltage is applied to the load, and the second boosted voltage is applied to the load when the first boosted voltage is unstable. Therefore, an output voltage ripple and a voltage drop may be prevented, so that driving voltages of the display device may be stabilized by the stable boosted voltage.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A voltage generator comprising:
a first voltage booster configured to boost an input voltage to generate a first boosted voltage; and
a second voltage booster configured to boost the input voltage to generate a second boosted voltage when the first boosted voltage is out of a predetermined range.

2. The voltage generator of claim 1, wherein the input voltage is applied to the second voltage booster when the first boosted voltage is applied a the load, and the second boosted voltage is applied to the load when the input voltage is applied to the first voltage booster.

3. The voltage generator of claim 1, further comprising:
a voltage comparison section that compares the first boosted voltage with a reference voltage; and
a switching control section that operates the second voltage booster in response to an output of the voltage comparison section.

4. The voltage generator of claim 1, further comprising:
a current comparison section that compares the current corresponding to the first boosted voltage with a reference current; and
a switching control section that operates the second voltage booster in response an output of to the current comparison section.

5. A voltage generator comprising:
a first voltage booster that boosts an input voltage to generate a first boosted voltage applied to a load; and
a second voltage booster that boosts the input voltage to generate a second boosted voltage applied to the load when the first boosted voltage is lower than a reference voltage.

6. A voltage generator comprising:
a first voltage booster that boosts an input voltage to generate a first boosted voltage applied to a load; and
a second voltage booster that boosts the input voltage to generate a second boosted voltage applied to the load when a current corresponding to the first boosted voltage is smaller than a reference current.

7. A method of generating a voltage, comprising:
boosting an input voltage to generate a first boosted voltage; and
boosting the input voltage to generate a second boosted voltage when the first boosted voltage is out of a predetermined range.

8. The method of claim 7, wherein the second boosted voltage is applied to the voltage generator when the first boosted voltage is applied to the load, and the second boosted voltage is applied to the load when the first boosted voltage is applied to the voltage generator.

9. The method of claim 7, wherein the second boosted voltage is generated by:
comparing the first boosted voltage with a reference voltage to generate a first comparison signal and a second comparison signal; and
selectively generating the second boosted voltage in response to the first and second comparison signals.

10. The method of claim 7, wherein the second boosted voltage is generated by:
comparing a current corresponding to the first boosted voltage with a reference current to generate a first comparison signal and a second comparison signal; and
selectively generating the second boosted voltage in response to the first and second comparison signals.

11. A display device comprises:
a first display panel that includes a first substrate having:
a first display region that includes a plurality m of first data lines and a plurality n of first gate lines;
a first peripheral region that is adjacent to the first display region; and
a first gate driving section that is formed at the first peripheral region to generate first gate signals to the first gate lines; and
a driving section to generate a first driving voltages to the first display panel by using a first and second boosted voltages, wherein the second boosted voltage is generated when the first boosted voltage is out of a predetermined range.

12. The display device of claim 11, wherein the driving section is disposed at the first peripheral region.

13. The display device of claim 11, further comprising a second display panel that is electrically connected to the first display panel and includes a second substrate, the second substrate including:
a second display region that includes a plurality j of second data lines and a plurality i of second gate lines to display an image;
a second peripheral region; and
a second gate driving section that is integrated at the second peripheral region to generate second gate signals to the second gate lines.

14. The display device of claim 13, wherein the second gate driving section generates second gate driving voltages to the second display panel.

15. The display device of claim 13, wherein the number m of the first data lines is larger than the number j of the second data lines.

16. The display device of claim 13, wherein the number n of the first gate lines is larger than the number j of the second gate lines.

17. The display device of claim 11, wherein the driving section comprises:
a first voltage booster that boosts an input voltage to generate a first boosted voltage;
a plurality of voltage generation sections that generate the driving voltages from the first boosted voltage; and
a second voltage booster that boosts the input voltage to generate a second boosted voltage when the first boosted voltage is out of a predetermined range.

18. The display device of claim 17, wherein the second boosted voltage is generated by the second voltage booster when the first boosted voltage is generated by the voltage generation sections.

19. The display device of claim 17, wherein the driving section further comprises:
a voltage comparison section that compares the first boosted voltage with a reference voltage to generate a first comparison signal and a second comparison signal; and
a switching control section that activates the second voltage booster in response to the first and second comparison signals.

20. The display device of claim 17, wherein the driving section further comprises:
a current comparison section that compares the current corresponding to the first boosted voltage with a reference current to generate a first comparison signal and a second comparison signal; and
a switching control section that activates the second voltage booster in response to the first and second comparison signals.

21. The display device of claim 11, wherein the driving section comprises:
a first gate control section that generates first gate control signals that are applied to the first gate driving section; and
a data driving section that generates a data voltage that is applied to the data lines.

22. The display device of claim 13, further comprising a second gate control section that generates second gate control signals that are applied to the second gate driving section.

23. The display device of claim 21, wherein the voltage generation sections comprise:
a gate voltage generation section that generates a first gate voltage to operate the first gate driving section; and
a gamma voltage generation section that generates a gamma reference voltage to generate the data voltages.

24. The display device of claim 22, wherein the gate voltage generation section generates a second gate voltage to operate the second gate driving section.

25. An apparatus for driving a display device including a display panel having an array substrate that includes a display region, a peripheral region and a gate driving section, the display region including a plurality of data lines and a plurality of gate lines, the gate driver being formed at the peripheral region to generate gate signals applied to the gate lines, the apparatus comprising:
a data driving section that converts image data into data voltages based on a gamma reference voltage and applies the data voltages to the data lines;
a gate control section that generates gate voltages and gate control signals applied to the gate driver; and
a voltage generation section that generates the gamma reference voltage and the gate voltages by using a first boosted voltage, and that generates the gamma reference voltage and the gate voltage by using the first and a second boosted voltage when the first boosted voltage is out of a predetermined range.

26. The apparatus of claim 25, wherein the data driver, the gate control section and the voltage generation section are formed as a chip that is mounted on the peripheral region.
